(19) United States
(12) Patent Application Publication
(10) Pub. No.: US 2020/0325780 A1
(43) Pub. Date: Oct. 15, 2020

(54) A TURBOMACHINE BLADE OR VANE HAVING A VORTEX GENERATING ELEMENT

(71) Applicant: Siemens Aktiengesellschaft, Munich (DE)

(72) Inventors: Anthony Davis, Bassingham, Lincoln (GB); John David Maltson, Skellingthorp, Lincoln (GB)

(73) Assignee: Siemens Aktiengesellschaft, Munich (DE)

(21) Appl. No.: 16/096,975

(22) PCT Filed: Apr. 28, 2017
(86) PCT No.: PCT/EP2017/060296

§ 371 Date: Oct. 26, 2018

(30) Foreign Application Priority Data
May 4, 2016 (EP) 16168424.6

(51) Int. Cl. F01D 5/18

(52) U.S. Cl. CPC F01D 5/187; F05D 2260/22141; F05D 2250/241; F05D 2250/232; F05D 2250/21; F05D 2260/2212

(57) ABSTRACT

A turbomachine component has an aerofoil that includes a suction side wall and a pressure side wall bordering an aerofoil cavity. The turbomachine component has at least one cooling channel, for flow of a cooling fluid, extending inside the aerofoil cavity. The cooling channel has an inlet for receiving the cooling fluid and a series of turbulators positioned inside the cooling channel. The turbomachine component includes at least one vortex generating element positioned at the inlet of the cooling channel upstream of the turbulators or positioned adjacent to and upstream of the inlet of the cooling channel. The cooling fluid flows about and contiguous with the vortex generating element before the cooling fluid reaches the turbulators. The vortex generating element generates a swirl in the cooling fluid before the cooling fluid reaches the turbulators.

### CROSS REFERENCE TO RELATED APPLICATIONS

This application is the US National Stage of International Application No. PCT/EP2017/060296 filed Apr. 28, 2017, and claims the benefit thereof. The International Application claims the benefit of European Application No. EP16168424 filed May 4, 2016. All of the applications are incorporated by reference herein in their entirety.

### FIELD OF INVENTION

The present invention relates to gas turbines, and more particularly to blades or vanes of gas turbines with cooling channels.

### BACKGROUND OF INVENTION

Cooling of gas turbine components, such as a turbine blade or a vane is a major challenge and an area of interest in turbine technology. A common technique for cooling a turbine blade/vane, i.e. blade and/or vane, is to have one or more internal passages, referred to as cooling channels or cooling passages, within the blade/vane and to flow a cooling fluid, such as cooling air through the cooling channel. Surfaces of such cooling channel or channels are often lined with turbulators to enhance the heat transfer into the cooling air from the blade/vane internal surfaces forming surfaces of the cooling channel. Often a series of rib turbulators or pin-fin turbulators are arranged along the flow path of the cooling fluid within the cooling channel. The turbulators induce turbulence in the cooling fluid and thereby increase the efficiency of the heat transfer.

The flowing cooling fluid passes over, about and/or around the sequentially arranged rows or members of the turbulators and a rate of heat acceptance by the cooling fluid is increased as the cooling fluid passes over from a turbulator positioned first to downstream turbulators i.e. a turbulator positioned third or fourth in the series, and from there onwards the rate of heat acceptance by the cooling fluid as it passes on to further downstream turbulators, for example a turbulator positioned seventh or eighth in the series, remains substantially constant. Thus the rate of heat acceptance, and thereby an effectiveness of cooling by the cooling fluid passing over a series of sequentially arranged turbulators, increases from the very first turbulator towards the third or fourth turbulator and there it reaches a peak value.

Furthermore, the first turbulator itself is positioned downstream of an inlet of the cooling channel by a distance, primarily due to manufacturing and design constraints. Thus there is a delay in reaching peak value of cooling efficiency between an instance when the cooling fluid enters the inlet of the cooling channel till an instance when the cooling fluid crosses the position of the third or the fourth turbulator of the series of turbulators positioned inside the cooling channel. Thus there is a scope of improvement in a turbomachine component with cooling channels and turbulators by shortening the delay between the instance when the cooling fluid enters the inlet of the cooling passage and when the cooling efficiency reaches the peak value.

### SUMMARY OF INVENTION

Thus an object of the present disclosure is to provide a technique by which in a turbomachine component having an aerofoil and a cooling channel, a cooling effect of a cooling fluid passing through the cooling channel reaches a peak faster and thus enhancing an efficiency of cooling in the turbomachine component.

The above objects are achieved by a turbomachine component according to the present technique. Advantageous embodiments of the present technique are provided in dependent claims. Features of the independent claim can be combined with features of dependent claims, and features of dependent claims can be combined together.

The present technique presents a turbomachine component which has an aerofoil. An example of such turbomachine component is a blade or a vane for a turbomachine or a gas turbine engine. The aerofoil of the turbomachine component includes a suction side wall and a pressure side wall. The side walls, namely the suction side wall and the pressure side wall bordering an aerofoil cavity. The turbomachine component also has at least one cooling channel that extends inside at least a part of the aerofoil cavity. The cooling channel is for flow of a cooling fluid, when present. The cooling channel has an inlet that receives the cooling fluid which then flows through the cooling channel. The cooling channel also has a series of turbulators positioned inside the cooling channel. The cooling fluid flows over and about the turbulators. The turbomachine component includes at least one vortex generating element, hereinafter also referred to as the element. The element is positioned at the inlet of the cooling channel upstream of the turbulators or is positioned adjacent to and upstream of the inlet of the cooling channel. The cooling fluid flows about and contiguous with the element before the cooling fluid reaches the turbulators. The element generates a swirl in the cooling fluid before the cooling fluid reaches the turbulators.

The swirl includes generating a vortex and/or disturbing a stream lined flow and/or generating turbulence. As a result of the swirl generation the cooling effect of the cooling fluid reaches a peak faster than a scenario where the element is not present. In other words, if the cooling fluid were to reach its peak cooling effect after crossing three sequentially arranged turbulators inside the cooling channel, then due to the action of the element, when present according to the present technique, the cooling fluid reaches its peak cooling effect before crossing three sequentially arranged turbulators inside the cooling channel and thus faster. This results in increased efficiency of cooling by the cooling fluid flow.

In an embodiment of the turbomachine, the inlet of the cooling channel is present in the aerofoil cavity, and thus the element is positioned in the aerofoil cavity.

In an embodiment of the turbomachine component, the turbomachine component includes a base wherefrom the aerofoil extends radially. The base is used to fix the turbomachine component to a desired position in the turbomachine. For example the base may in a blade or a vane and may aid in fixing the aerofoil of the blade or the vane onto their respective disks. The base, especially in a blade of a turbomachine, has a circumferentially extending platform and a root section radiating out of the platform in a direction opposite to the aerofoil. The turbomachine component, such as the blade or the vane, may also have a tip, for example a shroud, which is present at an end of the aerofoil that is opposite to the base. The base may have a base cavity, for example a root cavity and/or a platform cavity, and the cooling channel may be supplied with the cooling air through the base cavity and thus the inlet of the cooling channel may be present either in the base, fluidly connected with the base cavity, or may be in the aerofoil but in close proximity of the base. In such a turbomachine component, the element may be positioned within the base, for example in the root cavity or in the platform cavity.

In the turbomachine component, the tip may have a shroud cavity and the cooling channel may be supplied with the cooling air through the shroud cavity and thus the inlet of the cooling channel may be present either in the shroud, connected with the shroud cavity, or may be in the aerofoil but in close proximity of the shroud. In such a turbomachine component, the element may be positioned within the shroud, i.e. the tip of the turbomachine component.

The element may be formed as a protrusion emerging out from a surface at which the vortex generating element is positioned i.e. the protrusion is formed projecting out of the surface but as a part of the surface and not as a separate entity from the surface. The protrusion emerging out from the surface may be formed for example by casting the surface and the protrusion together. Alternatively, the element may be a fixture attached to the surface at which the element is positioned, for example if the element is separately formed and then glued onto the surface.

The element may have a shape selected from a rib shape, split-rib shape, wedge shape, split-wedge shape, pin fin shape, conical shape with straight side, conical frustum shape with straight side, conical shape with curved side, conical frustum shape with curved side, spherical dome shape, tetrahedron shape, tetrahedral frustum shape, pyramidal shape, and pyramidal frustum shape. It may be noted that the element is meant to be representative of one or more individual members. An example of the element having one member is where the element is a rib extending on the parallel to a surface where the turbulators of the cooling channel are present and normal to direction of flow of cooling air when entering the inlet. An example of the element having more than one member is if the element is a split rib which may be visualized as smaller ribs formed by dividing a larger rib perpendicularly to a longitudinal axis of the larger rib and then spacing apart the smaller ribs along the longitudinal axis.

The element, or each member of the element in case where the element has more than one member, may have dimensions relative to the turbulators, for example a height of the element is between 50 percent and 150 percent of a height of the turbulators, especially when the turbulators are rib shaped. In one embodiment a height of the element is greater than the height of the cooling channel, thus physically differentiating the turbulators positioned inside the cooling channel from the element positioned outside the cooling channel. Similarly, the element, or each member of the element in case where the element has more than one member, may have dimensions relative to the cooling channel, for example a height of the element is between 10 percent and 40 percent of a height of the cooling channel at the inlet, especially when the turbulators inside the cooling channel are pin fin shaped. If the cooling channel is of a rectangular or triangular cross section the height at the inlet is the largest height of the cooling channel in the same direction as that measuring the height of the element.

### BRIEF DESCRIPTION OF THE DRAWINGS

The above mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 shows part of a turbine engine in a sectional view and in which an aerofoil of the present technique is incorporated;

FIG. 2 schematically illustrates a perspective view of an exemplary embodiment of a turbomachine component with an aerofoil;

FIG. 3 schematically illustrates a cross-section of an exemplary embodiment of the aerofoil normal to a longitudinal axis of the aerofoil;

FIG. 4 schematically illustrates a vertical section of the turbomachine component depicting an exemplary embodiment of a vortex generating element according to the present technique;

FIG. 5 schematically illustrates a perspective view of an exemplary embodiment of the turbomachine component depicting a portion of an inside of the turbomachine component;

FIG. 6 schematically illustrates an exemplary embodiment of the vortex generating aerofoil having a conical frustum shape with a curved side;

FIG. 7 schematically illustrates another exemplary embodiment of the vortex generating aerofoil having a wedge shape;

FIG. 8 schematically illustrates another exemplary embodiment of the vortex generating aerofoil having a split-wedge shape;

FIG. 9 schematically illustrates another exemplary embodiment of the vortex generating aerofoil having multiple members with a tetrahedron shape; and

FIG. 10 schematically illustrates another exemplary embodiment of the vortex generating aerofoil having a pin fin shape; in accordance with aspects of the present technique,

FIG. 11 schematically illustrates another exemplary embodiment of the vortex generating aerofoil having a conical frustum shape with a curved side and in particular certain aspect ratios.

### DETAILED DESCRIPTION OF INVENTION

Hereinafter, above-mentioned and other features of the present technique are described in details. Various embodiments are described with reference to the drawing, wherein like reference numerals are used to refer to like elements throughout. In the following description, for the purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

As mentioned hereinabove, in a turbomachine component cooled by the flow of a cooling fluid though a cooling channel having sequentially arranged turbulators, a peak of cooling is reached after the cooling fluid crosses the third or the fourth turbulator in the series, thus the delay. The reason the cooling fluid reaches a peak value of heat acceptance after this delay is that turbulence starts setting into the flow of the cooling fluid only after the cooling fluid encounters the very first turbulator within the cooling passage or channel and an optimum turbulence in the flow of the cooling fluid is reached by further two or three encounters between the flowing cooling fluid and turbulators immediately downstream of the first turbulator.

The basic idea of the present disclosure to shorten or obviate this delay is by introducing a turbulence or swirl in the cooling fluid immediately before the cooling fluid enters the cooling channel through an inlet of the cooling channel or by introducing a turbulence or swirl in the cooling fluid as the cooling fluid enters the cooling channel through the inlet of the cooling channel, i.e. by introducing the swirl in the cooling fluid before the cooling fluid reaches the first turbulator. The introduction of the swirl in the cooling fluid is achieved, according to the present technique, by positioning a vortex generating element either at the inlet of the cooling channel upstream of the turbulators or by positioning the vortex generating element adjacent to and upstream of the inlet of the cooling channel. The positioning of the vortex generating element is such that the cooling fluid has to flow about the vortex generating element before the cooling fluid enters the cooling passage and/or reaches the turbulators. The vortex generating element generates a swirl in the cooling fluid by having a shape that induces swirling of the fluid or generation of vortices in the cooling fluid flow before the cooling fluid reaches the turbulators. The turbulence or swirl is initiated by highly unsteady flow features that are created by the vortex generating device in the cooling air. These features include vortex shedding, fluid shear layers within the passage containing flow recirculations and flow separations and unstable shear layers that do not have a stable location.

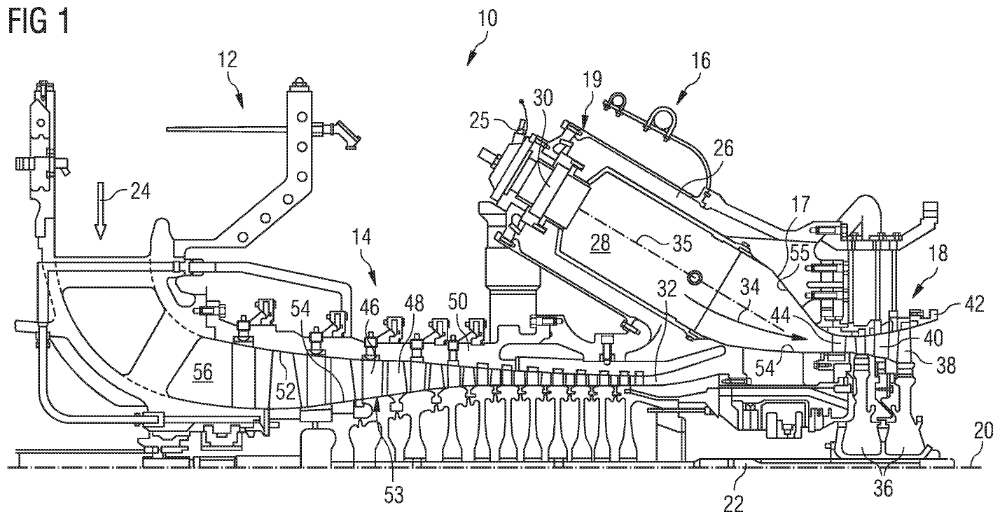

FIG. 1 shows an example of a gas turbine engine 10 in a sectional view. The gas turbine engine 10 comprises, in flow series, an inlet 12, a compressor or compressor section 14, a combustor section 16 and a turbine section 18 which are generally arranged in flow series and generally about and in the direction of a longitudinal or rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a longitudinal axis 35 of the burner, a burner plenum 26, one or more combustion chambers 28 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channelled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channelling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38.

The combustion gas from the combustion chamber 28 enters the turbine section 18 and drives the turbine blades 38 which in turn rotates the shaft 22. The guiding vanes 40, 44 serve to optimise the angle of the combustion or working gas on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operational conditions.

The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present technique is described with reference to the above exemplary turbine engine having a single shaft or spool connecting a single, multi-stage compressor and a single, one or more stage turbine. However, it should be appreciated that the present technique is equally applicable to two or three shaft engines and which can be used for industrial, aero or marine applications.

The terms upstream and downstream refer to the flow direction of the airflow and/or working gas flow through the engine unless otherwise stated. The terms forward and rearward refer to the general flow of gas through the engine. The terms axial, radial and circumferential are made with reference to the rotational axis 20 of the engine.

It may be noted that the present technique has been explained in details with respect to an embodiment of a turbine blade, however, it must be appreciated that the present technique is equally applicable and implemented similarly with respect to a turbine vane or any other turbomachine component having an aerofoil and being cooled by a cooling channel with turbulators arranged inside the cooling channel.

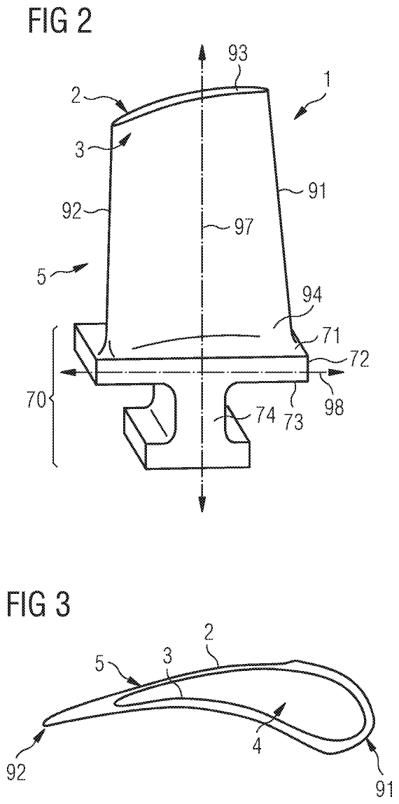

FIG. 2 schematically illustrates a turbomachine component 1 having an aerofoil 5, for example the turbine blade 38 or the vane 40 of FIG. 1. FIG. 3 illustrates a cross section of the aerofoil 5 of the turbomachine component 1, hereinafter also referred to as the blade 1. In the blade 1, the aerofoil 5 extends from a platform 72 in a radial direction 97, and more particularly from a side 71, hereinafter referred to as the aerofoil side 71, of the platform 72. The platform 72 extends circumferentially i.e. along curved axis 98. From another side 73, hereinafter referred to as the root side 73, of the platform 72 emanates a root 74 or a fixing part 74. The root 74 or the fixing part 74 may be used to attach the blade 1 to the turbine disc 38 (shown in FIG. 1). The root 74 and the platform 72 together form a base 70 in the blade 1. It may be noted that in some other embodiments of the turbomachine component 1, the root 74 may not be present and the base 70 is then formed only of the platform 72 which may be an integrally fabricated part of a larger structure (not shown) such as a stator disc in the turbine section 16 of the engine 10, as shown in FIG. 1.

The aerofoil 5 includes a suction side wall 2, also called suction side 2, and a pressure side wall 3, also called pressure side 3. The side walls 2 and 3 meet at a trailing edge 92 on one end and a leading edge 91 on another end. The aerofoil 5 has a tip end 93. The aerofoil 5 may be connected to a shroud (not shown) at the tip end 93 of the aerofoil 5. In some other embodiments the aerofoil 5 may be connected to a tip platform (not shown) instead of the shroud. The shroud and the tip platform are commonly referred to a tip (not shown) of the turbomachine component 1. The aerofoil 5 may also include a shroud (not shown) at the tip end 93 of the aerofoil 5. The side walls 2 and 3 of the aerofoil 5 act as boundary for an aerofoil cavity 4.

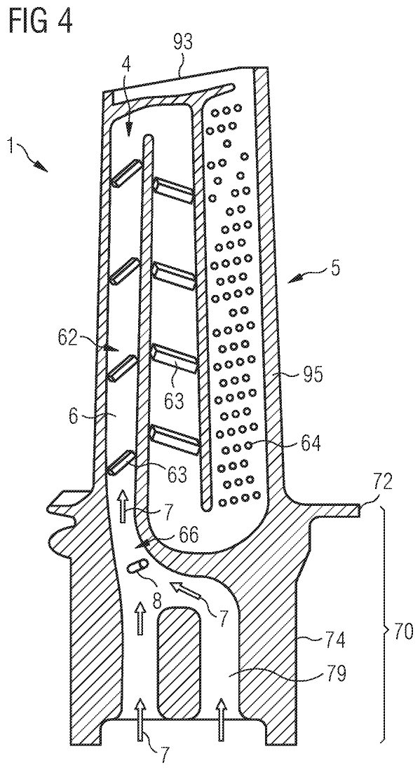

Referring to FIG. 4, an exemplary embodiment of the turbomachine component 1, i.e. the blade one has been explained hereinafter. The blade 1 has at least one cooling channel 6 that extends inside at least a part of the aerofoil cavity 4. A cooling fluid, such as cooling air, has been represented by arrows marked with reference numeral 7. The cooling fluid 7 flows through the cooling channel 6. The cooling channel 6 has an inlet 66 that receives the cooling fluid 7 which then flows through the cooling channel 6. The cooling channel 6 usually has a serpentine path though the aerofoil cavity 4. The cooling channel 6 also has a series of turbulators 62 positioned in a sequential manner with respect to the flow of the cooling fluid 7 inside the cooling channel 6. The turbulators 62 inside the cooling channel 6 may be rib shaped 63 or pin fin (pedestal) shaped 64. The cooling fluid 7 flows over and about the turbulators 62. The cooling fluid 7 after flowing through the cooling channel 6 and the turbulators 62 exits the cooling channel 6 for example by holes 95 that fluidly connect the cooling channel 6 to an outside of the aerofoil 5. The holes 95 may be present at any region of the aerofoil 5 for example at the trailing edge 92.

The blade 1 includes at least one vortex generating element 8, hereinafter also referred to as the element 8. The element 8 is positioned at the inlet 66 of the cooling channel 6 upstream of the turbulators 62. The element 8 may also be positioned adjacent to and upstream of the inlet 66 of the cooling channel 6 as depicted in FIG. 4. The cooling fluid 7 flows over and/or about the element 8. At least a part of the cooling fluid 7 flows while contacting the element 8. The external shape of the element 8 is such that turbulence or swirl is introduced in the flowing cooling fluid 7 as a result of contacting or flowing around the element 8. The shape and dimensions of the element 8 are such that turbulence is generated, for example a vortex or vortices are generated in the flowing cooling fluid 7, before the flowing cooling fluid 7 reaches the turbulators 62 positioned inside the cooling channel 6. As a result of the swirl generation the cooling effect of the cooling fluid 7 reaches a peak faster than a scenario where the element 8 is not present. In other words, if the cooling fluid 7 were to reach its peak cooling effect after crossing three sequentially arranged turbulators 62 inside the cooling channel 6, then due to the action of the element 8, introduced by the presence of the element 8, when present according to the present technique, the cooling fluid 7 reaches its peak cooling effect before reaching three sequentially arranged turbulators 62 inside the cooling channel 6 and hence faster.

The element in FIG. 4 is positioned at the base 70, and more precisely within the platform 72, since the inlet 66 of the cooling channel 6 is within the platform 72 but, the inlet 6 may be immediately downstream of the platform 72. However, in other embodiments (not shown) the inlet 66 of the cooling channel 6 may be downstream of the platform 72 and well within the aerofoil cavity 5, and in such embodiments the element 8 is positioned within the aerofoil cavity 5.

Referring to FIG. 5, another exemplary embodiment of the blade 1 is depicted. In this embodiment, in contrast to embodiment of the blade 1 of FIG. 4, the aerofoil 5 accommodates multiple distinct cooling channels 6, for example two cooling channels 6 depicted in FIG. 5. Each of the cooling channels 6 has its respective inlet 66 and the element 8 is positioned at the inlet 66 or upstream of the inlet 66 for one or both of the cooling channels 6.

Alternatively, the cooling channels 6 may be arranged such that one of the cooling channels 6 opens in the aerofoil cavity 4 and the other cooling channel 6 has its inlet 66 at the aerofoil cavity 4, hereinafter also referred to the cavity 4. In such an embodiment, the element 8 for the other cooling channel 6 is positioned inside the cavity 4.

As depicted in FIG. 5, the element 8 may have either one member as shown for the inlet 66 towards the leading edge 91 of the aerofoil 5 or may have multiple members, together referred to as the element 8, as shown for the inlet 66 towards the trailing edge 92 of the aerofoil 5. Furthermore, the element 8 corresponding to the inlet 6 towards the leading edge 91 of the aerofoil 5 has been depicted to be upstream of the corresponding inlet 6, whereas the multiple members, together referred to as the element 8, corresponding to the inlet 66 towards the trailing edge 92 of the aerofoil 5 have been depicted to be at the inlet 66.

It may be noted that both for FIGS. 4 and 5, the base 70 may have a base cavity 79, for example a root cavity (now shown) and/or a platform cavity (not shown), and the cooling channel 6 may be supplied with the cooling air 7 through the base cavity 79 and thus the inlet 66 of the cooling channel 6 may be present in the base 70, fluidly connected with the base cavity 79. In such a turbomachine component 1, the element 8 may be positioned within the base 70, for example in the root cavity or in the platform cavity.

Furthermore, in an exemplary embodiment of the turbomachine component 1, the tip, i.e. for example a shroud (not shown) may have a shroud cavity (not shown) and the cooling channel 6 may be supplied with the cooling air 7 through the shroud cavity and thus the inlet 66 of the cooling channel 6 may be present either in the shroud, connected fluidly with the shroud cavity, or may be in the aerofoil 5 but in close proximity of the shroud. In such embodiments of the turbomachine component 1, the element 8 may be positioned within the shroud, i.e. the tip of the turbomachine component 1.

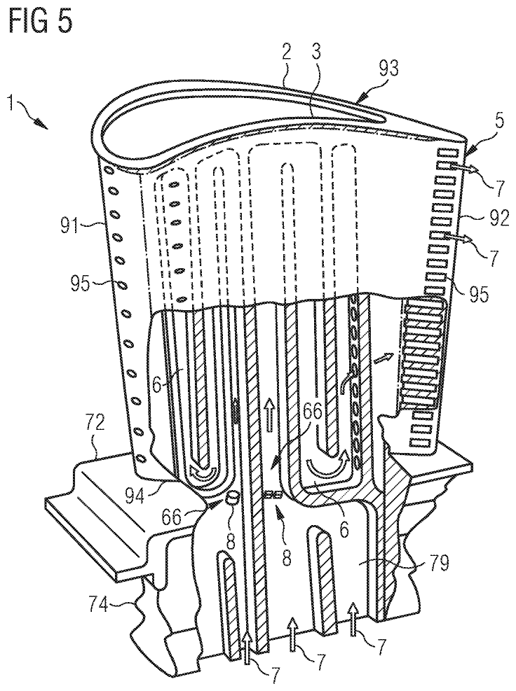

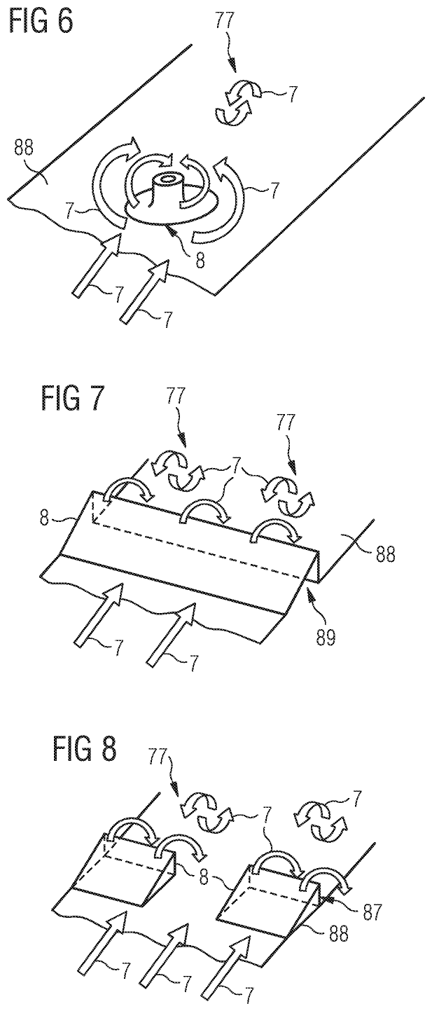

Referring now to FIGS. 6 to 10, different shapes for the element 8 have been depicted. As shown in FIG. 6, the element 8 may have a conical frustum shape with a curved edge. The cooling air 7, after contact flow or flowing around the element 8, is made to swirl by forming vortex 77. FIG. 7 shows an embodiment of the element 8 where the element 8 has a wedge shape whereas FIG. 8 shows an embodiment of the element 8 where the element 8 has a split-wedge shape.

As shown in FIG. 7, the element 8 may be formed as a protrusion 89 emerging out from a surface 88 at which the element 8 is positioned i.e. the protrusion 89 is formed projecting out of the surface 88 but as a part of the surface 88 and not as a separate entity that has been glued onto the surface 88. Alternatively, as shown in FIG. 8, the element 8 may be a fixture 87 attached to the surface 88 at which the element 8 is positioned. The fixture 87 is glued onto the surface 88 or may be fixed using any conventional method of fixing.

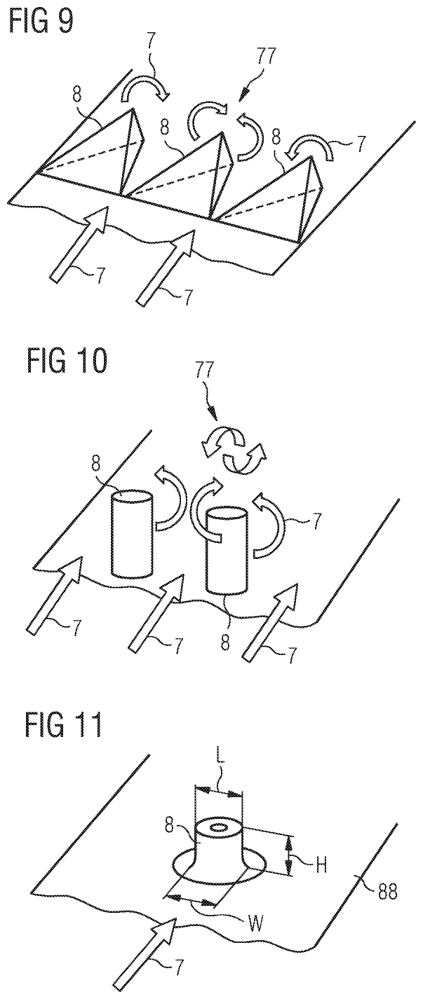

Besides the embodiments for the element 8 depicted in FIGS. 6 to 8, the element 8 may also have a shape selected from a rib shape (not shown), split-rib shape (not shown), pin fin shape as shown in FIG. 10, conical shape with straight side (not shown), conical frustum shape with straight side (not shown), conical shape with curved side (not shown), spherical dome shape (not shown), tetrahedron shape (shown in FIG. 9), tetrahedral frustum shape (not shown), pyramidal shape (not shown), or pyramidal frustum shape (not shown).

It may also be noted that the element 8 is meant to be representative of one or more individual members, for example as shown in FIG. 5.

The element 8, or each member of the element 8 in case where the element 8 has more than one member, may have dimensions relative to the turbulators 62 that are present within the cooling channel 6, for example a height of the element 8 is between 50 percent and 150 percent of a height of the turbulators 62, especially when the turbulators 62 are rib shaped turbulators 63. Similarly, the element 8, or each member of the element 8 in case where the element has more than one member, may have dimensions relative to the cooling channel 6, for example a height of the element 8 is between 10 percent and 40 percent of a height of the cooling channel 8 at the corresponding inlet 66, especially when the turbulators 62 inside the cooling channel are pin fin shaped 64.

It may be noted that in some cases the same cooling channel 6 may have more than one type of turbulators 62 for example the rib shaped turbulators 63 and the pin fin shaped turbulators 64, as depicted in the exemplary embodiment of FIG. 4. In such a case the height of the element 8 is selected according to the type of the turbulators 62 that are immediately downstream of the element 8, for example the height or dimensions of the element 8 for the embodiment depicted in FIG. 4 are selected according to the rib turbulators 63 i.e. in this embodiment the height of the element 8 may be between 50 percent and 150 percent of the height of the rib turbulators 63 inside the cooling channel 6. However, in an alternate embodiment i.e. if the type of the turbulators 63 that are immediately downstream of the element 8 were pin fin shaped turbulators 64 then the height of the element 8 is selected according to the pin fin turbulators 64 for example the height of the element 8 may be between 10 percent and 40 percent of the height of the cooling channel 6 at the inlet 66.

In an embodiment of the element 8, and in reference to FIG. 11, but which can be applied to the other embodiments herein, the element 8 has a height H which is perpendicular to the surface of the cooling channel it extends from, a width W which is perpendicular to the direction of the cooling flow 7 and a length L which is parallel and in the direction of the cooling flow. The aspect ratio W to L is in the range 0.75 to 1. The aspect ratio of height H to length L is in the range 0.5 and 2.0. Thus the cross-sectional shape can be circular, oval or other polygon that fits into the aspect ratios cited in this paragraph. Furthermore, the aspect ratio may change from one cross-section to another cross-section along any direction of the three mutually perpendicular directions indicated by H, W and L. In the direction of the height H the aspect ratio W to L is advantageously constant; however the element 8 can taper in one or both directions W and L from the surface of the cooling channel towards its free end.

Furthermore, the height H of the element 8 can be up to ⅓ the cooling channel 6 width i.e. the dimension of the cooling channel 6 in the direction of the height of the element 8.

It is necessary for the element 8 to be located upstream of the cooling channel turbulators 63 and effectively in a clear line-of sight of the turbulators 63 such that the vortices or swirl in the cooling fluid 7 generated by the element 8 are effective and impinge on the turbulators 63. No other features such as obstructions or bends in the cooling channel 6 should be between the element 8 and the turbulators 63. The element 8 is located on the same part of the surface of the cooling channel 6 as the turbulators 63 to have the best effect. This is to ensure that the turbulence or vortices from the element 8 interact with the turbulators 63 enhancing their effectiveness.

The element 8 is located in the cooling channel 6 symmetrical about a plane through a central line of the cooling channel 6. The central line of the cooling channel 6 may be curved bearing in mind the general three-dimensional shape of the component and the cooling channel 6.

It will be appreciated by the skilled person that the turbulators 63 have a much greater aspect ratio W to L because they substantially span across the cooling channel and are designed to cause turbulence to interact with the surface of the cooling channel. This is in contrast to the vortex generator elements 8 which are designed, by virtue of their aspect ratios to create turbulence within the stream of cooling fluid before the cooling fluid interacts with the turbulators 63. Furthermore, the pedestals 64 span the entire ‘height’ of the cooling channel because they are design to enhance the surface area for heat transfer purposes.

While the present technique has been described in detail with reference to certain embodiments, it should be appreciated that the present technique is not limited to those precise embodiments. Rather, in view of the present disclosure which describes exemplary modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

### LIST OF REFERENCE CHARACTERS

1 turbomachine component
2 suction side wall
3 pressure side wall
4 aerofoil cavity
5 aerofoil
6 cooling channel
7 cooling fluid
8 vortex generating element
10 gas turbine engine
12 inlet
14 compressor section
16 combustor section or burner section
17 transition duct
18 turbine section
19 combustor cans
20 rotational axis
22 shaft
24 air
26 burner plenum
28 combustion chamber
30 burner
31 position of flame
32 diffuser
34 combustion gas or working gas
35 longitudinal axis
36 blade carrying discs
38 turbine blades
40 guiding vanes
42 stator
44 inlet guiding vanes
46 vane stages
48 rotor blade stages
50 casing
52 radially outer surface
53 rotor drum
54 radially inner surface
56 passage
62 turbulators
63 rib turbulators
64 pin turbulators
66 inlet of the cooling channel
70 base
71 aerofoil side of the platform
72 platform
73 root side of the platform
74 root
77 vortex
87 fixture
88 surface
89 protrusion
91 leading edge
92 trailing edge
93 tip end of the aerofoil
94 base end of the aerofoil
95 holes
97 longitudinal axis of the aerofoil
98 circumferential direction

1. A turbomachine component, comprising:
an aerofoil,
a suction side wall of the aerofoil and a pressure side wall of the aerofoil bordering an aerofoil cavity, and
at least one cooling channel extending inside at least a part of the aerofoil cavity, wherein the cooling channel is adapted to be flowed through by a cooling fluid and wherein the cooling channel comprises an inlet for receiving the cooling fluid to be flowed through the cooling channel and a series of turbulators positioned inside the cooling channel for flow of the cooling fluid,
at least one vortex generating element positioned at the inlet of the cooling channel upstream of the turbulators or positioned adjacent to and upstream of the inlet of the cooling channel, wherein the vortex generating element is adapted to be flowed about and contiguously by the cooling fluid before the cooling fluid reaches the turbulators and wherein the vortex generating element is further adapted to generate a swirl in the cooling fluid before the cooling fluid reaches the turbulators.

2. The turbomachine component according to claim 1,
wherein the turbomachine component comprises a base wherefrom the aerofoil extends radially.

3. The turbomachine component according to claim 2,
wherein the base comprises a circumferentially extending platform wherefrom the aerofoil extends radially.

4. The turbomachine component according to claim 3,
wherein the base comprises a root extending radially from the platform opposite to the aerofoil.

5. The turbomachine component according to claim 2,
wherein the turbomachine component comprises a tip positioned at an end of the aerofoil opposite to the base.

6. The turbomachine component according to claim 5,
wherein the vortex generating element is positioned within the tip.

7. The turbomachine component according to claim 1,
wherein the vortex generating element is positioned within the aerofoil cavity.

8. The turbomachine component according to claim 4,
wherein the vortex generating element is positioned within the base.

9. The turbomachine component according to claim 8,
wherein the vortex generating element is positioned within the platform.

10. The turbomachine component according to claim 8,
wherein the vortex generating element is positioned within the root.

11. The turbomachine component according to claim 1,
wherein the vortex generating element is a protrusion formed from a surface at which the vortex generating element is positioned.

12. The turbomachine component according to claim 1,
wherein the vortex generating element is a fixture attached to a surface at which the vortex generating element is positioned.

13. The turbomachine component according to claim 1,
wherein the vortex generating element has a shape selected from a rib shape, split-rib shape, wedge shape, split-wedge shape, pin fin shape, conical shape with straight side, conical frustum shape with straight side, conical shape with curved side, conical frustum shape with curved side, spherical dome shape, tetrahedron shape, tetrahedral frustum shape, pyramidal shape, and pyramidal frustum shape.

14. The turbomachine component according to claim 1,
wherein the vortex generating element has a height (H) which is perpendicular to a surface of the cooling channel it extends from, a width (W) which is perpendicular to a direction of the cooling flow and a length (L) which is parallel and in the direction of the cooling flow,
wherein an aspect ratio W to L is in a range of 0.75 to 1.

15. The turbomachine component according to claim 14,
wherein an aspect ratio of height (H) to length (L) is in a range of 0.5 and 2.0.

16. The turbomachine component according to claim 1,
wherein a height of the vortex generating element is between 10 percent and 40 percent of a height of the cooling channel at the inlet.

17. The turbomachine component according to claim 1,
wherein the aerofoil is a blade or a vane for a gas turbine engine.
